(19) United States
(12) Patent Application Publication
(10) Pub. No.: US 2002/0082010 A1
(43) Pub. Date: Jun. 27, 2002

(54) Wireless terminals and methods including power efficient intelligent roaming and scanning for a communication service provider

(76) Inventors: Havish Koorapaty, Cary, NC (US); Keith Anderson, Durham, NC (US); Nadi Findikli, Cary, NC (US); Dave Hoover, Cary, NC (US)

Correspondence Address: MYERS BIGEL SIBLEY & SAJOVEC, PO BOX 37428, RALEIGH, NC, 27627, US

(21) Appl. No.: 09/748,073

(22) Filed: Dec. 22, 2000

(51) Int. Cl. H04Q 7/20

(52) U.S. Cl. 455/434; 455/574

(57) ABSTRACT

Power-up systems and methods are provided for a wireless terminal which uses multiple stages of decreasing search complexity in scanning radio channels for service when no service is available. Complexity may be reduced by scanning radio channels for service according to a variable sequence whose composition reflects a higher occurrence of higher priority radio frequency bands than lower priority radio frequency bands, so that higher priority radio frequency bands will be scanned more often than lower priority radio frequency bands. In addition, by turning wireless terminal off for increasing time intervals after each scan, the power-up scan techniques may provide reduced power consumption. By reducing the search complexity during successive stages of scanning, the power-up scan techniques may ensure that the wireless terminal responds quickly and finds a service provider when service does become available.

The written description provided herein contains acronyms which refer to, for example, various telecommunication services, components and techniques, as well as features relating to the present invention. Although some of these acronyms are known, use of these acronyms may not be standardized in the art. For purposes of the written description herein, acronyms will be defined as follows:

Advanced Mobile Phone Service (AMPS)

Application Specific Integrated Circuit (ASIC)

Analog Control Channel (ACC)

Code Division Multiple Access (CDMA)

Digital Control Channel (DCCH)

Digital Control Channel History Table (DHT)

Dynamic Random Access Memory (DRAM)

Digital Signal Processor (DSP)

Electronically Erasable Programmable Read Only Memory (EEPROM)

Federal Communications Commission (FCC)

Global System for Mobile Communications (GSM)

Intelligent Roaming Data Base (IRDB)

Intelligent Roaming Mode (IR Mode)

Interim Standard (IS)

Last Acceptable Band (LAB)

Liquid Crystal Display (LCD)

Mobile Identification Number (MIN)

Mobile Switching Center (MSC)

Number Assignment Module (NAM)

Personal Communications Network (PCN)

Personal Communications Services (PCS)

Private Operating Frequency (POF)

Random Access Memory (RAM)

Received Signal Strength (RSS)

Service Provider (SP)

System Access List (SAL)

System Identification Code (SID)

System Operator Code (SOC)

Time Division Multiple Access (TDMA)

### BACKGROUND OF THE INVENTION

The present invention relates generally to the field of wireless communications methods and apparatus, and, more particularly, to the acquisition of a communication service provider upon power-up of a wireless terminal.

Wireless communications systems are commonly employed to provide voice and/or data communications to subscribers. It will be understood by those having skill in the art that the term “wireless terminal” is used herein to include analog and digital radiotelephones, multiple mode radiotelephones, high function Personal Communications Systems (PCS) devices that may include large displays, scanners, full size keyboards and the like, and laptop, palmtop and pervasive computing devices that include wireless communications capabilities.

Analog cellular wireless communications systems, such as those designated AMPS (Advanced Mobile Phone System), NMT (Nordic Mobile Telephone)-450 and NMT-900, have long been deployed successfully throughout the world. By contrast, digital cellular wireless communications systems such as those conforming to the North American standard TIA/EIA-136 and the European standard GSM (Global Systems for Mobile Communications) have been in service since the early 1990s. More recently, a wide variety of wireless digital services broadly labeled as PCS (Personal Communications Services) have been introduced. PCS can be implemented via high function wireless terminals that provide functions in addition to those of a cellular telephone, such as facsimile, data communications, data processing, word processing, and other personal communications systems functions. Multiple mode wireless communication terminals that embody two or more of these functions also are included. Other wireless communication terminals that may omit a display and/or a microphone also are included.

A current trend is to utilize digital transmission for speech and/or data traffic. Modern digital wireless systems typically utilize different multiple access techniques such as Time Division Multiple Access (TDMA) and/or Code Division Multiple Access (CDMA) to provide increased spectral efficiency. A number of digital cellular standards are in use that are based on Time Division Multiple Access (TDMA). TDMA systems include the TIA/EIA-136 (D-AMPS) system and the GSM system, also known as DCS1800 when used in the 1800 MHz band and as PCS1900 when used in the U.S. 1900 MHz PCS bands. In TDMA systems, such as those conforming to the GSM or TIA/EIA-136 standards, carriers are divided into sequential time slots that are assigned to multiple channels such that a plurality of channels may be multiplexed on a single carrier. Ongoing development of TDMA standards continues to make improvements in service and product utility, such as longer battery life.

One feature introduced into the D-AMPS system, for example, is the Digital Control Channel (DCCH) which can reduce the standby battery consumption of wireless terminals that are camped on the DCCH to await calls. Unlike the AMPS broadcast control channel, the DCCH need not be a continuous carrier signal, but occupies only one slot of the 3-slot TDMA frame. The other two slots can contain traffic, but may be empty during periods of low demand. On the other hand, CDMA systems, such as those conforming to the TIA/EIA-95 standard, achieve increased channel capacity by using “spread spectrum” techniques wherein a channel is defined by modulating a data-modulated carrier signal by a unique spreading code, i.e., a code that spreads an original data-modulated carrier over a wide portion of the frequency spectrum in which the communications system operates. For more information on air-interface standards please refer to http://www.tiaonline.org.

PCS are implemented in systems, such as, advanced digital cellular systems conforming to standards such as TIA/EIA-136, lower-power systems such as DECT (Digital Enhanced Cordless Telephone), and data communications services such as CDPD (Cellular Digital Packet Data). These and other systems are described in The Mobile Communications Handbook, edited by Gibson and published by CRC Press (1996).

A major concern with such wireless communication systems is the continued reduction in the time that is needed to scan the wireless communication channels to identify a channel. In searching for a service provider, it is also known to equip multi-mode terminals which may support communication services with a variety of communication service providers with different protocols and implementations such as those described above. For example, it is known to provide dual mode terminals supporting both AMPS and TDMA. In addition, it is known to provide multi-mode terminals supporting multiple frequency band operation. An example is the Digital Advanced Mobile Phone System (D-AMPS) terminal discussed above, for use in the United States, where one of two alternate 800 megahertz (MHz) bands may be utilized to provide both analog and digital services in a particular geographic region. The utilized 800 MHz band may vary in different geographic regions. In addition, digital communication services may be supported by one of a number of different 1900 MHz bands.

As shown in FIG. 1, pursuant to regulations of the Federal Communications Commission (FCC) in the United States, for example, the two 800 MHz bands 14, 16 are typically designated “a” and “b”. In particular, the two frequency bands designated “a” 30, 32 and “b” 34, 36 can be 12.5 MHz each allocated in the 800 MHz region for the uplink 14 and the downlink 16, respectively. Thus, the total spectrum allocation is 25 MHz per band. On the other hand, the bands allocated in the 1900 MHz region can be each be designated “A” through “F”. The first three bands A to C 50-60 may have an allocation of 15 MHz each, while the bands D to F 62-72 can have allocations of 5 MHz each. Each of these bands may have, for instance, channels with 30 kHz carrier frequency spacing. Each of the bands may also be further divided into sub-bands (also called probability blocks) in the 800 MHz bands. A purpose of dividing the bands into sub-bands is to allow the system to specify the scanning procedure for the mobile terminal more precisely. The a and the b bands can be sub-divided into sixteen sub-bands each, the bands from A to C can be sub-divided into seven sub-bands each, and the bands from D to F can be sub-divided into three sub-bands each. In the future this band configuration will likely change. Presently, schemes such as these are used for TIA/EIA-136, GSM, CDMA and other systems.

Power consumption is an important consideration for mobile phones since lower power consumption can enable mobile phones to have longer standby times thus increasing their operability. Mobile phones operating in cellular systems such as TIA/EIA-136 are required to scan for acceptable service providers according to specific Intelligent Roaming (IR) procedures that are specified in TIA/EIA-136. These procedures define the order in which the mobile phone scans different channels and the priorities assigned to various service providers. The IR procedures typically use a pre-programmed database stored in the wireless terminal called the Intelligent Roaming Data Base (IRDB). The IRDB prioritizes the frequency bands and sub-bands to be scanned based on the probability of finding a preferred service provider within a band. It also stores other parameters such as the number of sub-bands to scan within a frequency band where the sub-band ordering in decreasing order of priority is pre-defined.

The respective priority of each frequency band typically depends on the status of the service provider that is licensed to use that band. The status of Service Providers (SP) is generally classified into five categories: home, partner, preferred, neutral and forbidden. These multiple service provider categories may be identified by matching the System Identification Code (SID) or System Operator Code (SOC) broadcast on a control channel with the entries in the IRDB. Each of these five categories may de defined as follows:

(1) home—service provider of choice and normally the service provider with whom the user has a service agreement. If a mobile communication device is registered on or finds a control channel for a home service provider, the device does not attempt to find service on any other frequency band.

(2) partner—a partner with the home service provider. If a mobile communication device is registered on or finds a control channel for a partner service provider, the device does not attempt to find service on any other frequency band.

(3) favored—a service provider with whom the home service provider has a preferential rate and/or service agreement. The mobile communication device will register with a favored service provider only if a home or partner service provider is not found. On the occurrence of certain events, such as a control channel change and/or periodically, the mobile communication device will search other frequency bands for a home or partner service provider.

(4) neutral—a service provider not identified by a SID or SOC entry in the IRDB. The mobile communication device will register on a neutral service provider if none of home, partner, or preferred service providers are found. On certain events such as a control channel change and/or periodically, the mobile communication device will search other frequency bands for a home, partner, or preferred service provider.

(5) forbidden—a service provider which is never used under normal circumstances.

Home and partner SPs may be grouped into one category as acceptable SPs depending on the state of a bit in the IRDB. On the other hand, favored and neutral SPs usually are grouped together as unacceptable SPs.

During operation of a wireless terminal, RF coverage may be unavailable for a wide variety of reasons. For example, RF coverage could be unavailable in elevators, tunnels, or other structures. On the other hand, RF coverage may also be unavailable when cellular service is not present in a given area. Moreover, lack of acceptable service providers in a particular area may be yet another reason coverage would be unavailable.

In the event RF coverage is unavailable, the wireless terminal must execute a power-up scan to find acceptance service providers. When a wireless terminal is powered on, it performs an initialization procedure with the wireless communications system. In general, the wireless terminal scans a plurality of channels and/or time slots in order to locate an appropriate control channel. Wireless terminals that operate in the U.S. AMPS system may only need to scan a limited number of channels at power-up in order to locate a broadcast control channel. For example, broadcast control channels can be confined to a small portion of the available spectrum about 1 MHz wide in order to reduce scan time. Moreover, since in AMPS the broadcast control channel transmissions generally are continuous transmissions, the receiver could alight on a scanned channel at any time and make a measurement. In analog cellular telephones it is known to scan channels in direct sequential order to minimize the frequency changing time from one channel to the next.

Currently, wireless terminals operating in a wireless communication system such as the TIA/EIA-136 cellular system search for acceptable service on all channels on which the terminal is designed to operate. As noted above, in a TDMA system the channel is typically defined by a frequency and a time slot, and in a CDMA system it is defined by a carrier frequency and a spreading code. Thus, a channel may be defined by a carrier frequency and/or a time slot and/or a spreading code.

Shown in FIG. 2 is a block diagram of a conventional power-up scan procedure 200 for a wireless terminal connected to an external power supply. By contrast, FIG. 3 is a block diagram showing a conventional power-up scan procedure 300 for a wireless terminal when not connected to an external power supply, for example when using battery power. These procedures are used by a wireless terminal to scan for service upon power-up or upon losing a channel. When a wireless terminal is unable to find any service using the power-up scan procedure, the power-up scan procedure must be repeated periodically in an attempt to find service.

As shown in FIG. 2, the power-up scan is started at Block 201 and is composed of at least three components. These are the Private Operating Frequency (POF) scan 202, the DCCH History Table (DHT) scan 204 and the wideband scan 206. In the POF scan 202, channels are scanned for private systems. A DCCH (Digital Control Channel) history table stores control channels recently camped on by the wireless terminal, and the DHT scan 204 searches those channels for service. In a wideband scan 206, an ordered search through all the channels in every frequency band as specified in an IRDB is made for a control channel with an acceptable SP. Between each scan operation, a determination is made at Blocks 203, 205 and 207, whether a communications channel is found. If so, the power-up scan ends at Block 210. On the other hand, if the communications channel is not found, then the power-up scan simply proceeds to the next scan Block 202, 204, 206 specified by the procedure. The procedures for scanning each band during a wideband scan are specified in Section 4.1.6.6. of TIA/EIA-136-123-B. As described in Section 4.1.6.6., particular techniques used in performing the wideband scan depend on whether scanning is being performed in a 800 or 1900 MHz band. Thus, when the wireless terminal is connected to an external power supply, as shown in FIG. 2, the power-up scan procedure continuously repeats itself until an SP is found.

By contrast, as shown in FIG. 3, when the wireless terminal is not connected to an external power supply, the power-up scan includes an Intelligent Roaming (IR) restart procedure 312. Thus, after examining all the bands, if no acceptable SP is found, then the wireless terminal must periodically restart the power-up scan procedure to find a service provider. However, while Section 4.1.6.2 specifies that a rescan process 8 must be repeated, Section 4.1.6.2 does not provide specific requirements as to how this should be done.

The specification of TIA/EIA-136-123-B specifies Intelligent Roaming methods that define wireless terminal search procedures associated with a variety of situations, such as: call release; intelligent roaming restart procedure; power-up scan; wideband scan; triggered scan, including triggered partial scan and triggered wideband scan; band scanning procedures for 800 MHz and 1900 MHz bands; emergency call procedure; analog fax; and data service. In particular, Section 4.1.6.3 of TIA/EIA-136-123-B provides a detailed description of a power-up scan procedure. The power-up scan will result in the wireless terminal station entering a DCCH camping state or settling on the highest priority SP available.

FIG. 4 is a flowchart of a power-up scan procedure reproduced from the TIA/EIA-136-123-B specification. This power-up scan procedure will now be explained as per the description given in the specification of TIA/EIA-136-123-B. Once the power-up scan is initiated, at Block A1, the signal strength of all the POFs stored in the wireless terminal station (i. e., that are identified as Acceptable SPs by the SID and/or SOC) is determined. If the Non-Public Priority Enable bit is set to 1, then the signal strength of all POFs may be measured, regardless of the SP category. At Block 403, the strongest two channels then are listed in order of signal strength, and the stronger signal of the two is selected. Next at Block A2/B3, if it is determined that the signal strength is below HISTORY_THRESHOLD, then the power-up scan procedure proceeds to Block 405, which is discussed below.

On the other hand, if it is determined at Block A2/B3 that the signal strength is above HISTORY_THRESHOLD, then the power-up scan procedure proceeds to Block A3/B4 where an attempt is made to synchronize to the channel. At Block A3/B4, if it is determined that the channel is not a DCCH, then the power-up scan procedure proceeds directly to Block A5/B6. By contrast, if the channel is a DCCH, then the power-up scan procedure proceeds to Block A4/B5. At Block A4/B5, if there is a POF match and the channel is suitable for camping based on the requirements of Section 4.2, the power-up scan procedure enters the DCCH camping state. If the wireless terminal station has not entered the DCCH camping state, then the power-up scan procedure proceeds to Block A5/B6. At Block A5/B6, the second strongest channel in the POF list is selected if it has not already been examined. If at Block 405 it is determined that the second strongest channel has already been examined, then the power-up scan procedure proceeds to Block B1. On the other hand, if at Block A5/B6 the channel is not the second strongest POF channel, then at Block 409, the power-up scan procedure selects the next strongest RSS channel on the list, and the power-up scan procedure proceeds to Block A2.

At Block B1, the status of the DHT Enable is examined. If the DHT Enable bit is set to one, then the power-up scan procedure proceeds to Block B2. On the other hand, if the DHT Enable bit is set to zero, then the power-up scan procedure proceeds to Block C1. At Block B2, the power-up scan procedure determines whether this is the first check of the DHT. If so, then the power-up scan procedure proceeds to select DHT channels in the Last Acceptable Band (LAB).

By contrast, if this is not the first check of the DHT, then the power-up scan procedure proceeds to select the next unchecked band in the IRBD band order. Also, at Block B2, the signal strengths of all the channels in the DHT are determined for the current band, and at Block 403, the strongest two channels are listed in order of signal strength with the maximum first. If it is determined at Block A2/B3 that the signal strength is below HISTORY_THRESHOLD, and at Block 405 it is determined that all DHT channels have been checked, then the power-up scan procedure proceeds to Block C1. By contrast, if it is determined at Block A2/B3. that the signal strength is above HISTORY_THRESHOLD, then the power-up scan procedure proceeds to Block A3/B4, where another attempt is made to synchronize to the channel. If the channel is not a DCCH, then the power-up scan procedure proceeds to Block A5/B6. Otherwise, the power-up scan procedure proceeds to Block A4/B5, where the wireless terminal station executes the Control Channel Selection procedure (see Section 4.2).

Still referring to FIG. 4, if, at Block A4/B5, the wireless terminal station has not entered the DCCH camping state, then the power-up scan procedure proceeds to Block A5/B6, where the second strongest channel in the DHT list is selected for the band under consideration. If this channel has not already been examined, then the power-up scan procedure proceeds through Block 409 to select the next strongest RSS channel on the list, and then proceeds to Block A2/B3. On the other hand, if at Block 405 it is determined that this channel has already been examined and there are remaining bands and channels in the DHT to be checked, then the power-up scan procedure proceeds to Block B1. If at Block 405 it is determined that there are no remaining channels to be checked in the DHT, then the power-up scan procedure proceeds to Block C1.

Continuing with the description of FIG. 4, at Block C1, a wideband scan is performed according to Section 4.1.6.4. A wideband scan is an ordered search through the bands resulting in success (i.e., entering the DCCH camping state or Idle task) or failure. Upon exiting a failed wideband scan, the wireless terminal station, if in a coverage area, shall have a list of favored, neutral and forbidden SPs encountered during the wideband scan. At Block C2, if it is determined that the only Home SPs are preferred or IR is disabled, then the power-up scan procedure proceeds to Block C7, discussed in detail below.

At Block C3, favored and neutral SPs found during a wideband scan are prioritized according to SP category first. Within the same category, multiple SPs shall be prioritized based on the band order specified in the IRDB.

Still referring to FIG. 4, at Block C4, the next channel in the priority ordering is examined, and, if none are left, then the power-up scan procedure proceeds to periodically restart the power-up scan at Block C7. At Block C5, if it is determined that the channel is suitable for camping, then the wireless terminal station shall enter the DCCH camping state and update the HSDB. If the wireless terminal station has not entered the DCCH camping state, then the power-up scan procedure proceeds to Block C6. At Block C6, if the channel is found unsuitable for camping, the entire band containing that channel is rescanned. The wireless terminal station shall enter the DCCH camping state or Idle task on any control channel in that band that it finds suitable but not Forbidden, and then update the HSDB. If a channel suitable for camping cannot be found in that band, then the power-up scan procedure proceeds back to Block C4 and examines the next channel in the priority ordering.

As discussed above, at Block C7, the power-up scan procedure periodically restarts the power-up scan. TIA/EIA-136-123-B specifies a recommended periodic rescan process in Section 4.1.6.2—Intelligent Roaming (IR) Restart Procedure. As illustrated in FIG. 4, Block C7 takes effect, for example, when (1) there is no coverage, (2) no control channels are found suitable for service, (3) the Home Only Enable bit or the IR DISABLE_FLAG is set to 1, or (4) only Forbidden SPs are found. While Block C7 specifies that the wireless terminal station shall periodically restart the power-up scan procedure from Block A1, no details are specified as to precisely how to restart the operation is to be carried out. Rather, these decisions are left to particular manufacturers.

According to Section 4.1.6.2, if (1) the wireless terminal station exits the power-up scan with no suitable SP, or (2) if the wireless terminal station enters the control channel scanning and locking state either (a) as a result of executing the suitable CAND_{—}1 not found procedure or (b) as a result of inability to complete the update digital overhead information task, then the wireless terminal station shall proceed by executing the Intelligent Roaming (IR) Restart Procedure.

According to the recommended Intelligent Roaming (IR) Restart Procedure, if the IR_DISABLE_FLAG is set, then the wireless terminal station shall initiate a power-up scan searching only for a home SP. The wireless terminal station shall continue to periodically scan until a home SP is found or the wireless terminal station is power cycled. If the IR_DISABLE_FLAG is not set, then the wireless terminal station shall initiate a power-up scan searching for the highest priority SP available. If scanning is unsuccessful, the wireless terminal station shall periodically repeat the IR scanning process.

Significantly, the manner in which the IR scanning process is repeated is determined by the wireless terminal manufacturer based on considerations such as trading off battery life for service acquisition time and vice-versa. For instance, when the wireless terminal station is powered through an external power supply, the manufacturer may choose to leave the wireless terminal station in continuous IR scanning since power consumption is not a consideration. By contrast, when the wireless terminal station is operating on a battery power, it is desirable that the manner in which IR scanning is repeated takes place as efficiently as possible so that battery life may be extended.

As discussed above, in the TIA/EIA-136 system, the manner in which the power-up scan is repeated by the wireless terminal is allowed to be chosen by the wireless terminal manufacturer so as to reduce power consumption in situations where no service is available. Accordingly, it is desirable that the power-up scan is repeated in a manner that can satisfy both of the potentially conflicting requirements of allowing power consumption to be low when no service is available, while quickly providing service to users as it becomes available.

Accordingly, there continues to be a need for wireless terminals and methods that can efficiently acquire a channel after the power-up scan procedure has failed. There is a particular need for IR restart procedures that can reduce scanning and acquisition time while allowing efficient use of battery power. As discussed above, conventional systems operating according to TIA/EIA-136 standard simply require the wireless terminal to repeat the power-up scan without specifying “intelligent” methods for doing so. Conventional wireless terminals operating according to TIA/EIA-136 standard may not efficiently direct the wireless terminal to a particular band or bands where the wireless terminal may obtain service on a preferred service provider when it is roaming.

### SUMMARY OF THE INVENTION

According to embodiments of the present invention, power-up systems and methods are provided for a wireless terminal which uses multiple stages of decreasing search complexity in scanning radio channels for service when no service is available. Complexity may be reduced by scanning radio channels for service according to a variable sequence whose composition reflects a higher occurrence of higher priority radio frequency bands than lower priority radio frequency bands, so that higher priority radio frequency bands will be scanned more often than lower priority radio frequency bands. Complexity may also be reduced by reducing the number of channels that are processed further during successive stages of scanning. In addition, by turning wireless terminal off for time intervals between each scan, embodiments of the present invention may provide reduced power consumption. This allows power savings while also allowing a channel to be found quickly. When a channel can not be found, by reducing amount of time the receiver is on, power is reduced during periods of scanning. This reduces the amount of time spent scanning which extends battery life during periods when no channels are found.

By reducing the search complexity during successive stages of scanning, the power-up scanning of embodiments of the present invention can allow the wireless terminal to respond quickly and find a service provider when service does become available.

According to first embodiments of the present invention, a first power-up process is performed to attempt to detect a wireless communications channel while consuming a first amount of power. Upon failure of the first power-up process to detect a wireless communications channel for the wireless terminal, a second power-up process is then performed to attempt to detect a wireless communications channel. Significantly, the second power-up process consumes a second amount of power that is less than the first amount. Power consumption of the wireless terminal can also be reduced by switching off at least one component of the wireless terminal prior to performing the second power-up process. Accordingly, battery life of a wireless terminal may be conserved when no service is available, or is intermittently available, in a given area.

Power savings are achieved both directly and indirectly by the present invention. For example, turning off the receiver between scans of bands of a direct factor that results in power savings. Another example of direct power savings is scanning a decreasing number of channels within a band during successive stages of scanning. By contrast, an indirect factor that results in power savings is the higher occurrence of higher priority bands than lower priority bands in the band scanning sequence BAND_SEQ. While this increases the probability of finding a wireless communications channel and therefore increases the probability of spending less power scanning, it does not directly contribute to saving power.

More specifically, according to embodiments of the present invention, during the first power-up process a first plurality of wireless communications channels can be scanned to attempt to detect a wireless communications channel, and during the second power-up process a second plurality of wireless communications channels that is less than the first plurality may be scanned to attempt to detect a wireless communications channel.

To allow reduced complexity during each successive scan, in other embodiments a decreasing number of the second plurality of communications channels may be repeatedly scanned to attempt to detect at least one pre-specified wireless communications channel. During scanning, selected ones of the second plurality of communications channels are preferably scanned more frequently than selected others of the second plurality of communications channels in each scan. For example, the selected ones of the second plurality of wireless communications channels may have a first priority designation, while the selected others of the second plurality of wireless communications channels may have a second priority designation that is lower than the first priority designation.

In other embodiments of the present invention, the second plurality of communications channels can be scanned and changes in the second plurality of communications channels can be detected. If changes are detected, the first power-up process may be re-performed.

Changes may be detected by measuring a first mean Received Signal Strength (RSS), rescanning each of the wireless communications channels, measuring a second mean Received Signal Strength (RSS), and determining whether the second mean RSS differs from the first mean RSS by more than a predetermined amount. The second power-up process can be stopped if the second mean Received Signal Strength (RSS) differs from the first mean Received Signal Strength (RSS) by more than a predetermined amount. The first power-up process is then re-performed.

In preferred embodiments, the first power-up process may comprise a power-up scan procedure in which a Private Operating Frequency (POF) scan is performed, a Digital control channel History Table (DHT) scan is performed, and a wideband scan is performed.

In other embodiments of the present invention, after the first power-up is performed it can be confirmed whether the step of performing the second power-up process should be executed. One way this can be done is by determining that the wireless terminal is not connected to an external power supply.

In further embodiments of the present invention, prior to repeatedly scanning the second plurality of communications channels, a Digital control channel History Table (DHT) scan may optionally be performed each time selected ones of the second plurality of communications channels are scanned. A private operating frequency scan may also be periodically performed before repeatedly scanning the second plurality of communications channels. Each time the second plurality of communications channels are repeatedly scanned, the number of channels on which RSS is measured can also be reduced.

In other embodiments, during the first power-up process a first plurality of frequency bands, each of which includes at least one communications channel, are scanned. During scanning of the first plurality of frequency bands, a highest priority frequency band can be scanned for a wireless communications channel. If no wireless communications channel is detected by scanning the highest priority frequency band, at least one lower priority frequency band can be scanned according to a sequence wherein higher priority bands are scanned more often than the lower priority bands. Preferably, more than one lower priority frequency band is scanned. For example, in certain embodiments every frequency band may be scanned at least once.

According to other embodiments of the present invention, power-up scan systems and methods are provided for attempting to detect a wireless communications channel for a wireless terminal. In response to failure of a preceding power-up process to detect a wireless communications channel, a power-up process is repeatedly performed while consuming decreasing amounts of power in each succeeding power-up process. Each succeeding power-up process is preferably performed after a delay time that increases with each succeeding power-up process. Search complexity may be further reduced by scanning selected ones of wireless communications channels more frequently than selected others of wireless communications channels in each successive scan. Accordingly, efficient scanning of frequency bands for a suitable service provider may be obtained.

In other embodiments, each succeeding power-up process may repeatedly scan a decreasing number of wireless communications channels to attempt to detect at least one pre-specified wireless communications channel.

According to other embodiments of the present invention, a power-up scan method is provided for a wireless terminal that accesses a wireless communications system. The power-up scan method uses a plurality of first communications channels having a first priority designation and a plurality of second communications channels having a second priority designation that is lower than the first priority designation. Preferably, the first communications channels are scanned more frequently than second communications channels in each scan. In response to failure of a preceding scan to detect a wireless communications channel for the wireless terminal, search complexity can be reduced. For example, a decreasing number of the first and second communications channels can be scanned in an attempt to detect at least one pre-specified wireless communications channel. Alternatively, an increasing number of the first communications channels relative to the second communications channels can be scanned during each scan.

In another embodiment, each successive scan may consume a lesser amount of power than the preceding scan. One way of accomplishing this is by performing each successive scan after a delay time that increases with each successive scan. Typically scanning of the communications channels takes place according to a fixed sequence, BAND_SEQ. However, in further embodiments of the present invention, search complexity may be reduced by repeatedly scanning the first and second communications channels according to a variable sequence. For instance, in one variable sequence the occurrence of the first communications channels may increase in proportion to the total number of communications channels scanned during each repeating scan.

In yet other embodiments of the present invention, a first and a second plurality of frequency bands, each of which includes at least one communications channel, are repeatedly scanned. Preferably, the repeated scanning of the first plurality of frequency bands comprises scanning a highest priority frequency band for a wireless communications channel, and if no wireless communications channel is detected by scanning the highest priority frequency band, at least one lower priority frequency band is scanned according to a sequence wherein higher priority bands are scanned with greater frequency than the lower priority bands. The number of first and second plurality of frequency bands may decrease during each successive scan.

According to other embodiments of the present invention, power-up scan systems and methods are provided for a wireless terminal that accesses a wireless communications system using a plurality of communications channels each of the channels having a predetermined priority. The plurality of communications channels include a group of higher priority communications channels and multiple groups of lower priority communications channels.

Although the plurality of communications channels are generally scanned according to a fixed sequence, the plurality of communications channels may be repeatedly scanned according to a variable sequence. For example, in one embodiment of a variable sequence, the occurrence of higher priority communications channels may increase in proportion to the total number of communications channels with each successive scan. Moreover, in another embodiment of a variable sequence, the number of the plurality of communications channels that is scanned is decreased during each successive scan. Thus, the terminal can find a service provider quickly by scanning the higher priority channels in the band more often. The power-up scan method of the present invention can also ensure that the wireless terminal finds a service provider quickly when service does become available. In further embodiments, each successive scan preferably consumes a lesser amount of power than the preceding scan, thereby conserving battery life of the wireless terminal.

According to other embodiments of the present invention, restart systems and methods are provided for a wireless terminal that accesses a wireless communications system using a plurality of groups of frequency bands. Each group of frequency bands has a relative priority designation. The plurality of groups of frequency bands are sequentially scanned such that groups of frequency bands having a high relative priority designation are scanned more frequently than groups of frequency bands having a lower relative priority designation. In addition, the number of bands in each group may decrease as the relative priority designation of that group increases.

As will be understood by those of skill in the art, the above-described embodiments of the invention may be used in combination. As will further be appreciated by those of skill in the art, the present invention may also be embodied as systems and methods and in all types of wireless communication terminals.

### BRIEF DESCRIPTION OF THE DRAWINGS

FIG. 1 illustrates a conventional communications spectrum organization showing channel bands.

FIG. 2 is a simplified flowchart illustrating operation of a conventional power-up scan when the wireless terminal is connected to an external power supply.

FIG. 3 is a simplified flowchart illustrating operation of a conventional power-up scan when the wireless terminal is not connected to an external power supply.

FIG. 4 is a reproduction of a flowchart illustrating operation of a power-up scan as specified by TIA/EIA-136-123-B.

FIG. 5A is a flowchart illustrating exemplary operations of power-up systems and methods for wireless terminals according to embodiments of the present invention.

FIG. 5B is a flowchart illustrating exemplary operations of embodiments of power-up systems and methods for wireless terminals according to embodiments of the present invention.

FIG. 5C is a flowchart illustrating exemplary operations of an aspect of the embodiments shown in FIG. 5B.

FIG. 5D is a flowchart illustrating exemplary operations of other embodiments of power-up systems and methods for wireless terminals according to embodiments of the present invention.

FIG. 5E is a flowchart illustrating exemplary operations of other embodiments of power-up systems and methods for wireless terminals according to embodiments of the present invention.

FIG. 5E is a flowchart illustrating exemplary operations of other embodiments of power-up systems and methods for wireless terminals according to embodiments of the present invention.

FIG. 5G is a flowchart illustrating exemplary operations of other embodiments of power-up systems and methods for wireless terminals according to embodiments of the present invention.

FIG. 6A is a flowchart illustrating exemplary operations of power-up scan systems and methods for wireless terminals according to other embodiments of the present invention.

FIG. 6B is a flowchart further illustrating the power-up shown in FIG. 6A.

FIG. 7 is a flowchart illustrating exemplary operations of a power-up for wireless terminals according to other embodiments of the present invention.

FIG. 8 is a flowchart illustrating exemplary operations of power-up systems and methods according to other embodiments of the present invention.

FIG. 9 is a flowchart illustrating exemplary operations of stage 1 of the power-up systems and methods shown in FIG. 8.

FIG. 10 is a flowchart illustrating exemplary operations of stages 2 and 3 of the power-up systems and methods shown in FIG. 8.

FIG. 11 is a schematic diagram illustrating one possible wireless communication terminal according to the present invention.

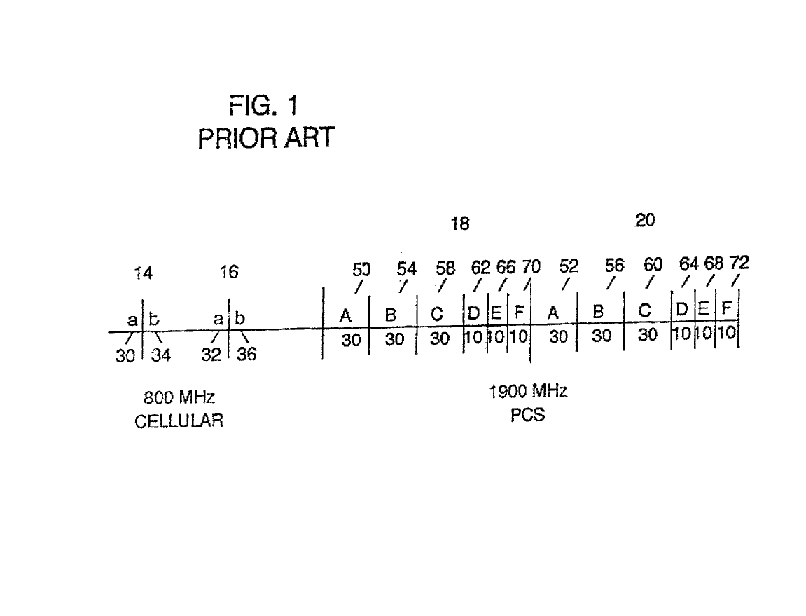

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

The description below assumes that the wireless communications system is an IS-136 network; however, the embodiments of the invention also can function in other wireless communications environments. Thus, the present invention described herein does not have any dependency on particular spectrum allocations. Moreover, while the invention is described in the context of the TIA/EIA-136 cellular system, the invention is independent of and equally applicable to air interface technologies such as Advanced Mobile Phone Service (AMPS), TDMA, CDMA, Personal Access Communication System (PACS) and PCS-1900.

The embodiments of the present invention are related to power-up methods and systems for a wireless terminal. These power-up methods and systems use multiple stages of decreasing search complexity in scanning radio channels for a service provider. For instance, complexity may be decreased by scanning according to a band sequence whose composition reflects a higher occurrence of higher priority radio frequency bands than lower priority radio frequency bands, so that higher priority radio frequency bands will be scanned more often than lower priority radio frequency bands. Complexity may also be decreased by reducing the number of channels that are processed during successive stages of scanning. By reducing the search complexity during successive stages of scanning, power-up scanning embodiments of the present invention can allow the wireless terminal to respond quickly and find a service provider when service does become available while reducing power consumption. Power consumption is reduced directly by turning the wireless terminal off for increasing time intervals between scanning operations. Power reduction is approximately proportional to the percentage of time that the receiver is turned off. At the same time, it is desirable that the receiver is not turned off for too long (e.g., more than 1 minute) so that the wireless terminal quickly responds when service finally does become available. Specific embodiments of the invention will now be discussed in detail.

As discussed herein a single band is a segment of spectrum that includes multiple wireless communications channels. Thus, a plurality of communications channels can be interpreted as a band or as a plurality of bands. According to power-up scan techniques specified herein, multiple bands can be scanned. In particular, the bands can be scanned according to an order or array referred to as BAND_SEQ. Preferably, individual bands are scanned one at a time, with a time delay between scanning of individual bands. The BAND_SEQ array is typically a fixed sequence that does not change. The BAND_SEQ array is generated by algorithms that will be described in detail herein. However, although BAND_SEQ is preferably a fixed band sequence, it may be advantageous to generate a new band sequence at each stage of the power-up scan. In other words, BAND_SEQ could be calculated at each stage of the power-up scan.

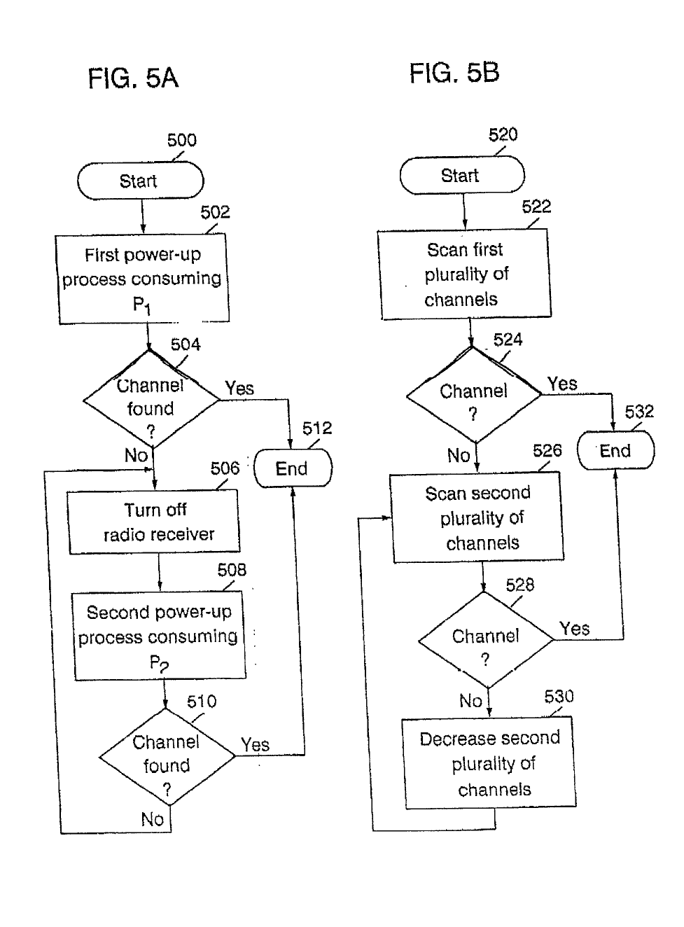

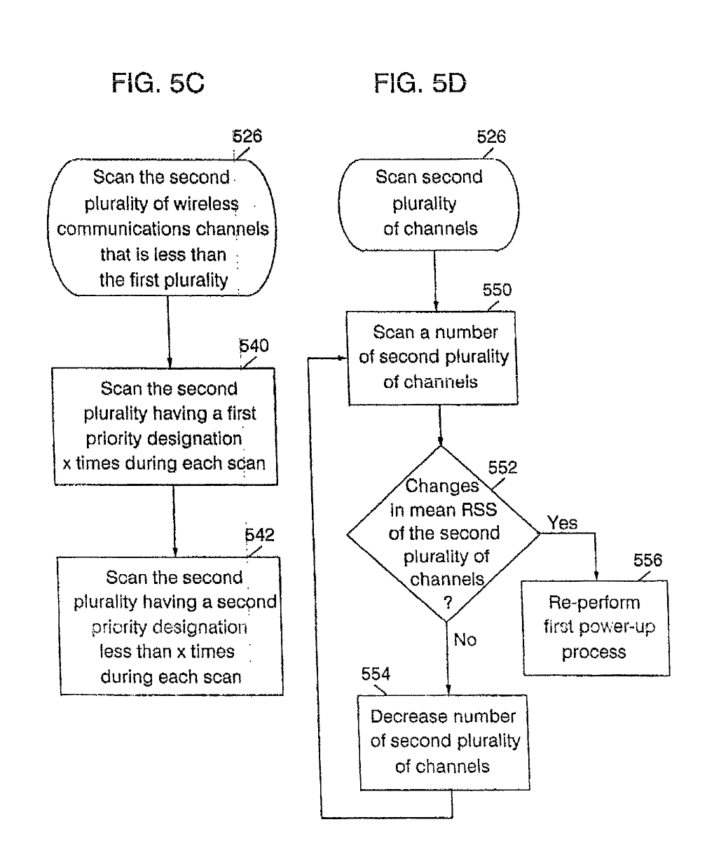

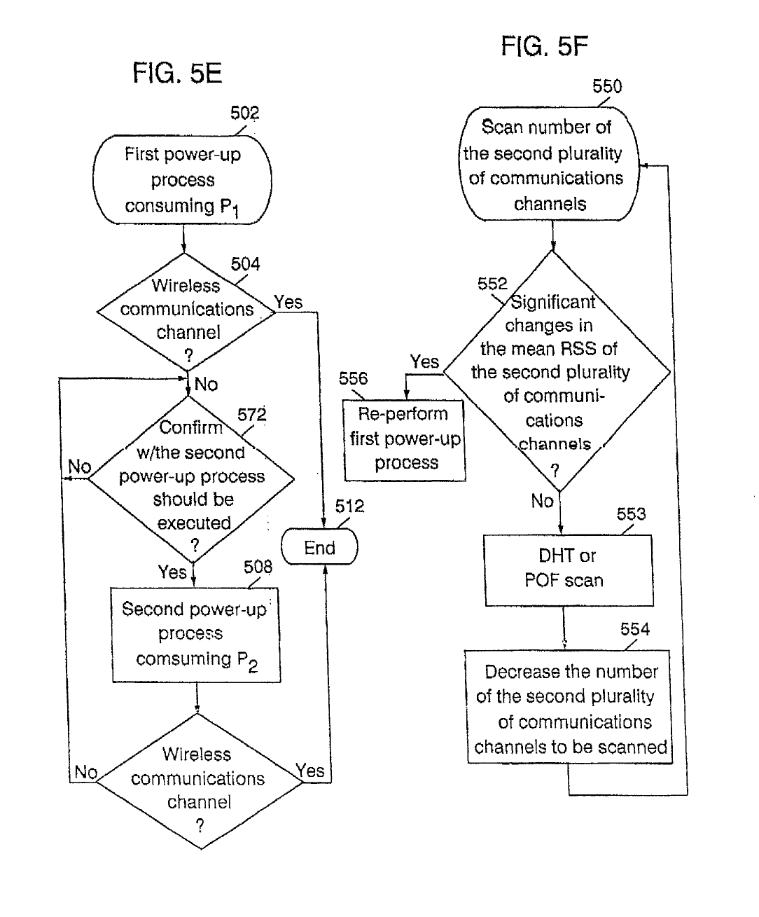

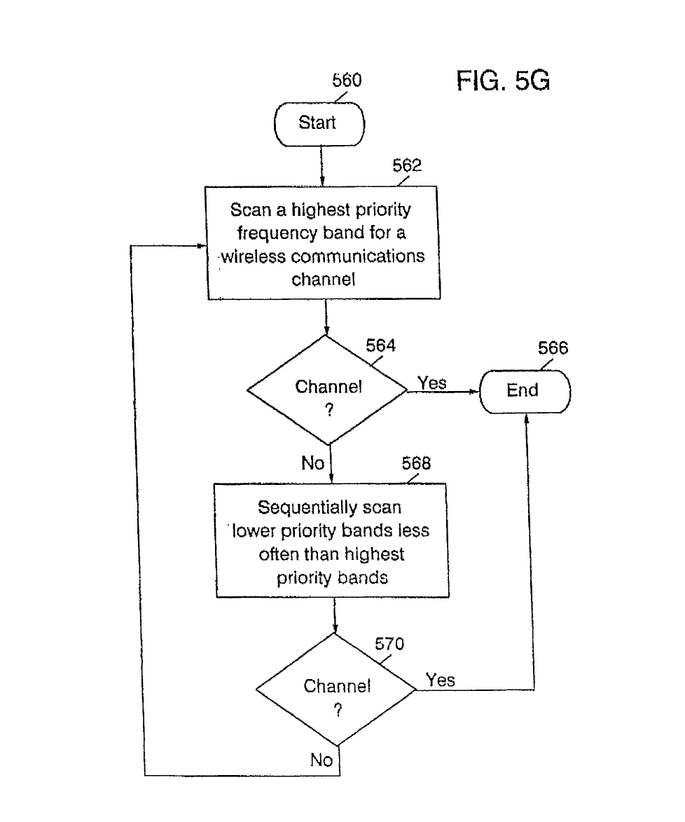

Referring now to FIG. 5A, a flowchart illustrating power-up systems and methods according to other embodiments of a wireless terminal is shown. After starting the power-up scan at Block 500, at Block 502 a first power-up process is performed to attempt to detect a wireless communications channel while consuming a first amount of power (P₁). At Block 504, upon failure of the first power-up process to detect a wireless communications channel for the wireless terminal, at Block 508 a second power-up process is then performed to attempt to detect a wireless communications channel. Significantly, the second power-up process consumes a second amount of power (P₂) that is less than the first amount of power P₁.

As noted above, the power reduction that occurs between the first and second power-up process may be achieved, for example, by switching off at least one component of the wireless terminal prior to performing the second power-up process. As a result, power consumption of the wireless terminal can be reduced, and battery life of a wireless terminal may be conserved significantly when no service is available (or is intermittently available) in a given area. As indicated by Block 510, if an acceptable wireless communications channel is detected, that channel is selected and the power-up process ends at 512. However, if an acceptable wireless communications channel is not detected at Block 510, then the wireless terminal is turned off at Block 506. The second power-up process is then repeated at Block 506 until a wireless communications channels is found.

FIG. 5B more specifically defines embodiments of the present invention shown in FIG. 5A. At Block 522, during the first power-up process, a first plurality of wireless communications channels can be scanned to attempt to detect a wireless communications channel. Again at Block 524, if an acceptable wireless communications channel is detected, that channel is selected and the power-up process ends.

On the other hand, if an acceptable channel is not detected at Block 522, then at Block 526, during the second power-up process, a second plurality of wireless communications channels may be scanned to attempt to detect a wireless communications channel. The second plurality of wireless communications channels can be the same as the first plurality of wireless communications channels or channels. For example, the second plurality may be less than the first plurality. If this scan is again unsuccessful, then at Block 530 the second plurality of communications channels may be repeatedly scanned to attempt to detect at least one pre-specified wireless communications channel. Optionally, the second plurality of communications channels may be decreased during each repeated scan.

At the same time this repeated scanning is taking place, as shown at Blocks 540 and 542 of FIG. 5C, it may be desirable that selected ones of the second plurality of communications channels can be scanned more frequently than selected others of the second plurality of communications channels in each scan. By scanning selected ones (e.g., higher priority) of the second plurality of communications channels in this manner, the probability of finding service quickly when it becomes available can be improved. As shown at Block 540 of FIG. 5C, selected ones of the second plurality of wireless communications channels may have a first priority designation. As shown in Block 542, selected others of the second plurality of wireless communications channels may have a second priority designation that is lower than the first priority designation. As a result, wireless communications channels having a first priority designation may be scanned more frequently than the wireless communications channels having a second priority designation.

FIG. 5D further specifies the details of scanning the second plurality of wireless communications channels as shown in Block 526. At Block 550, the second plurality of communications channels can be scanned. If desired, it should be appreciated that the complexity of the power-up scan method may be reduced even further by continuously decreasing the number of the second plurality of communications channels scanned. In Block 552, changes, if any, in the second plurality of communications channels can be detected. If changes are not detected at Block 552, a lesser number of the second plurality of communications channels may be selected at Block 554. On the other hand, if changes are detected at Block 552, then the first power-up process may be re-performed at Block 556.

One technique for detecting changes in the radio environment is shown in FIG. 5D. At Block 552, changes in the radio environment may be detected by measuring a first mean Received Signal Strength (RSS) using each of the wireless communications channels during a first scan of the bands according to BAND_SEQ. In Block 552, changes in the mean RSS may be detected by rescanning the wireless communications channels during a second scan of the bands according to BAND_SEQ, and then measuring a second mean RSS of the wireless communications channels. It can then be determined whether the second mean RSS exceeds the first mean RSS by more than a predetermined amount. Still referring to Block 552, the second power-up process can be stopped and exit into the power-up scan if the second mean RSS exceeds the mean RSS by more than a predetermined amount. The first power-up process is then re-performed at Block 556. Thus, the power-up method of the present invention may also advantageously detect changes in the radio environment during time periods where no service is available by detecting changes of more than a pre-set threshold in the mean signal level in a band.

On the other hand, as shown at Block 554, if there are not significant changes in the second mean RSS of the communications channels, the power-up method can proceed to decrease the number of the communications channels to be scanned, and re-execute Blocks 550 and 552. In embodiments in which the number of communications channels is decreased in each successive stage of scanning, the overall complexity of the power-up method can be reduced, thereby improving the probability of finding service quickly when it becomes available. Moreover, at Block 554, each time the communications channels are repeatedly scanned, the number of channels on which RSS is measured can be reduced. This further reduces complexity and allows for quick detection when service becomes available. As a result, power consumption may be reduced when scanning for a communications channel.

It should also be appreciated that changes in the radio environment may also be detected by comparing the RSS of adjacent wireless communications channels. Similarly, changes in the radio environment may also be detected by comparing the highest RSS in each band.

Referring now to FIG. 5E, in other embodiments of the present invention, after the first power-up is performed at Block 502, if no wireless communications channel is detected at Block 504, then it can be confirmed whether the second power-up process should be executed at Block 572. This can be done, for example, by determining that the wireless terminal is not connected to an external power supply. If the wireless terminal is connected to an external power supply, then it may be unnecessary to perform the second power-up process. Instead, the power-up can simply repeat the first power-up process continuously until a service provider is found since power consumption of the wireless terminal may no longer be a concern. By contrast, if the wireless terminal is not connected to an external power supply, then it is advantageous to perform the second power-up process for the reasons discussed above. In addition, it may be advantageous to repeat the first power-up process multiple times prior to performing the second power-up process since doing so may quickly find a service provider.

Referring now to FIG. 5F, it should be appreciated that in other embodiments of the present invention it may be advantageous, prior to repeatedly scanning a decreasing number of the second plurality of communications channels at Block 554, to perform a Digital control channel History Table (DHT) scan at Block 553 each time selected ones of the second plurality of communications channels are scanned. In yet another embodiment, a private operating frequency scan may be periodically performed at Block 553 before repeatedly scanning the decreasing number of the second plurality of communications channels at Block 554.

It should be recognized that the first power-up process may comprise a conventional power-up scan procedure in which a Private Operating Frequency (POF) scan is performed, a Digital control channel History Table (DHT) scan is performed, and a wideband scan is performed.

In other embodiments, during the first power-up process a first plurality of frequency bands, each of which includes at least one communications channel, are scanned. As shown in FIG. 5G, at Block 562, during scanning of the first plurality of frequency bands, a highest priority frequency band can be scanned to locate a wireless communications channel. If no wireless communications channel is detected at Block 564, then at Block 568, at least one lower priority frequency band can be scanned. The band that is scanned is selected according to a fixed band sequence, BAND_SEQ. Preferably, according to this sequence, then higher priority bands are scanned more often than the lower priority bands. The sequence preferably includes more than one lower priority frequency band. Essentially, bands having equal priorities based on the IRDB classification are included within the same group. Again, bands having a higher priority preferably occur more frequently in the sequence than bands having a lower priority. Moreover, the number of bands in each group preferably increases as the group priority decreases, such that higher priority groups contain relatively fewer bands than lower priority groups. The sequence can ensure that the same band is not consecutively scanned as well as increase the probability that a channel will be found. As shown at Block 570, any time an acceptable channel is found, the power-up method will end (Block 566). It should be recognized that if previous power-up scans for service repeatedly fail, then after a predetermined amount of time it may be advantageous to consider unacceptable service providers to be acceptable.

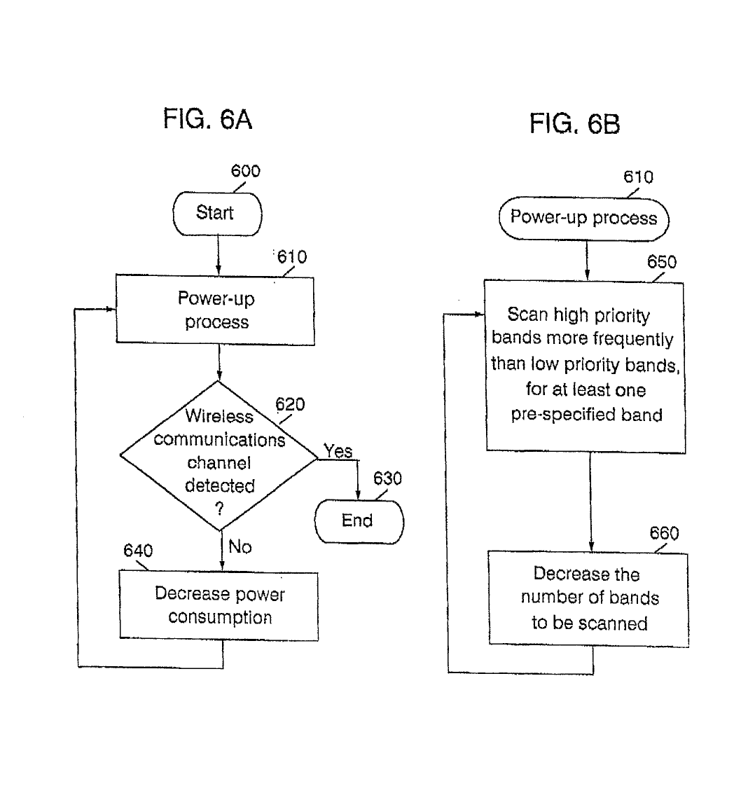

Other embodiments of the present invention are shown in FIG. 6A, which illustrates another power-up scan technique 600 for a wireless terminal used in detecting a wireless communications channel. According to these embodiments, in response to failure of a preceding power-up process (Block 610) to detect a wireless communications channel at Block 610, the power-up process at Block 610 is repeatedly performed while consuming decreasing amounts of power (Block 640) in each succeeding power-up process. FIG. 6B further defines the power-up scan process shown in Block 610 of FIG. 6A by specifying at Block 650 that search complexity may be further reduced by scanning high priority bands more frequently than low priority bands. This results in a reduction in complexity of the scanning process that can increase the probability that a channel is found when service becomes available, which, in turn, results in more efficient scanning. Optionally, as indicated at Block 660 of FIG. 6B, each succeeding stage of the power-up process may further comprise repeatedly scanning a decreasing number of bands to attempt to detect at least one wireless communications channel. Accordingly, scanning efficiency can be even further improved.

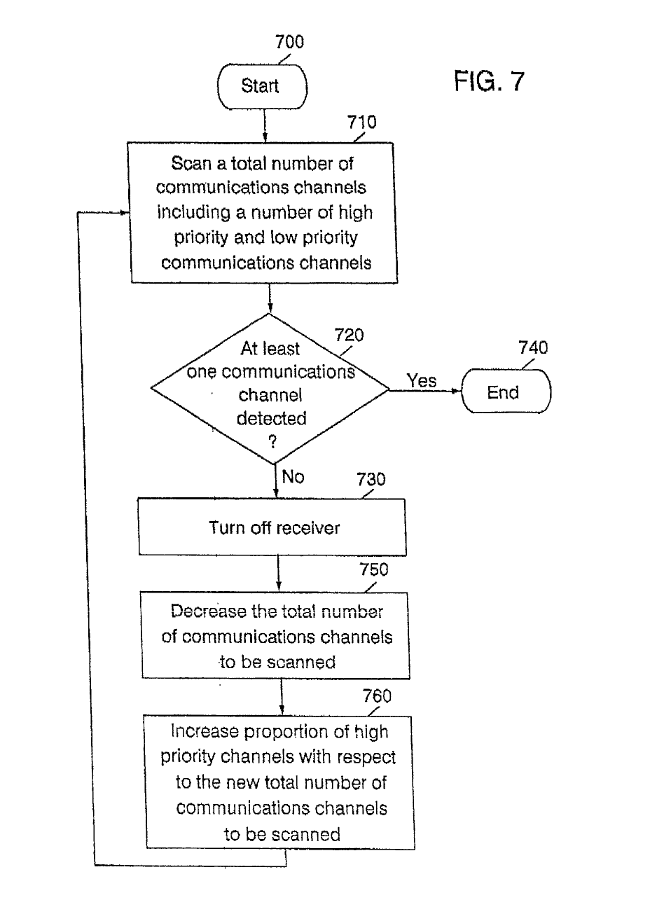

Other embodiments of the present invention are illustrated in FIG. 7, which shows yet another variation of a power-up scan technique for a wireless terminal that accesses a wireless communications system. At Block 710, the power-up scan technique scans a plurality of first communications channels having a first priority designation (e.g., high priority bands) and a plurality of second communications channels having a second priority designation (e.g., low or lower priority bands) that is lower than the first priority designation. The second priority designation may actually comprise multiple priority designations (i.e., multiple low priority bands of differing priorities) that are lower than the first priority designation. Optionally, at Block 750, in response to failure of a preceding scan to detect a wireless communications channel, search complexity can be reduced by scanning a decreasing number of the first and second communications channels to detect at least one pre-specified wireless communications channel.

Alternatively, in other embodiments, at Block 760, an increasing proportion of the first communications channels (i. e., high priority) with respect to the new total number of communications channels may optimally be scanned during each scan. Preferably, the first communications channels may be scanned more frequently than second communications channels in each scan, meaning that the number of high priority channels relative to the low priority channels can be increased during each successive scan.

Each successive scan may optionally consume a lesser amount of power than the preceding scan. At Block 730, one way of accomplishing this goal is by turning the receiver off for a predetermined time between successive scanning operations. The predetermined time should be selected in a manner to ensure quick acquisition of service when service becomes available. This predetermined time may be changed, either increased or decreased, during successive stages of the scanning operation.

In other embodiments, as shown in Block 760, search complexity may also be further reduced by repeatedly scanning the first and second communications channels according to a variable sequence wherein the occurrence of the first communications channels (i.e., high priority channels) increases in proportion to the total number of communications channels scanned during each successive scan.

Generally, as mentioned above, some power-up scan techniques of the present invention scan bands according to a fixed band sequence BAND_SEQ that does not change. However, in other embodiments of the present invention, a power-up scan technique for a wireless terminal is provided in which a decreasing number of a first and a second plurality of frequency bands are repeatedly scanned. Each of the frequency bands includes at least one communications channel. The repeated scanning of the first plurality of frequency bands may comprise the sub-steps of scanning at least one highest priority frequency band for a wireless communications channel. If no wireless communications channel is detected by scanning the highest priority frequency band, at least one lower priority frequency band is scanned according to a sequence. This sequence may result in higher priority bands being scanned with greater frequency than the lower priority bands.

In other embodiments of the present invention, a power-up scan technique is provided for a wireless terminal that accesses a wireless communications system using at least one communications channel. Each of the plurality of communications channels may have a predetermined priority. The plurality of communications channels may include a group of higher priority communications channels and multiple groups of lower priority communications channels. Typically, the groups of communication channels are scanned according to a predetermined sequence. If desired, however, the plurality of communications channels can be repeatedly scanned according to a variable sequence. For example, according to a preferred variable sequence, the occurrence of higher priority communications channels can increase in proportion to the total number of communications channels with each successive scan. To further reduce complexity of successive scans, during each successive scan a decreasing number of the plurality of communications channels may be scanned. Accordingly, the power-up scan method of the present invention can ensure that the terminal finds a service provider quickly when service does become available. Moreover, in order to conserve battery life, each successive scan preferably consumes a lesser amount of power than the preceding scan by turning the wireless terminal off between scans.

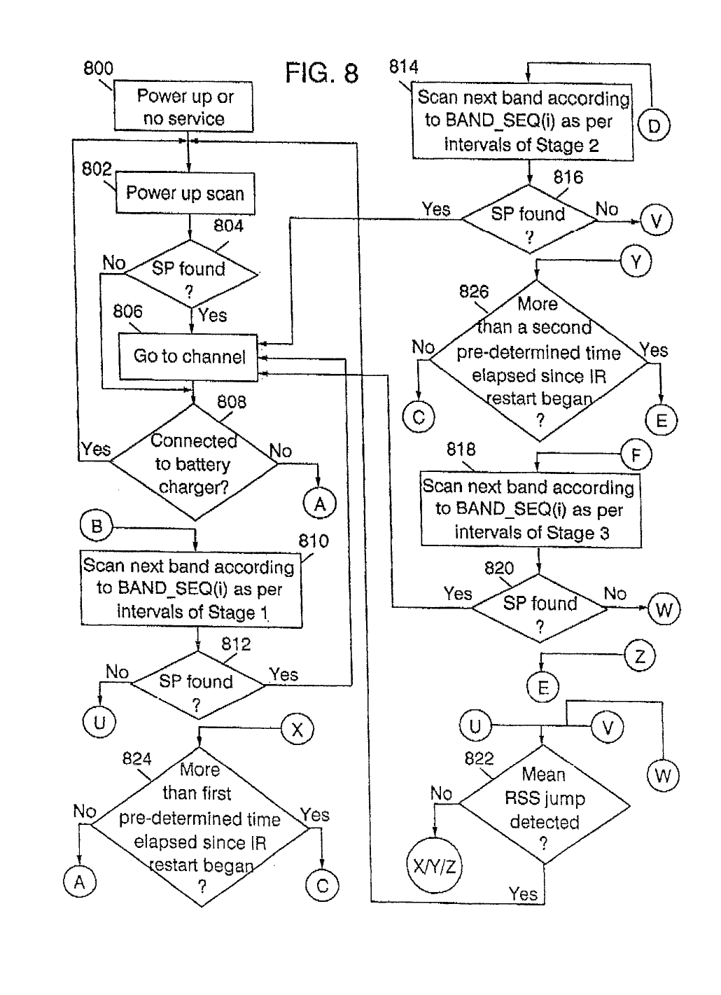

Referring now to FIG. 8, a detailed embodiment of a power-up scan technique will now be discussed. At Block 800 the wireless terminal conducts a power-up scan. If no service is presently available to the wireless terminal, (i.e., if the initial power-up scan fails), then the whole power up scan is immediately repeated. At Block 804, the power-up method again checks to see if a Service Provider (SP) has been found. This is done to again ensure that no service is available. If a service provider has been found, then at Block 806 the power-up method goes to the channel for that service provider. On the other hand, if the repeated power-up scan fails, at Block 808 it is determined whether the wireless terminal is connected to an external power supply. If at Block 808 it is determined that the wireless terminal is connected to an external power supply, then the power-up scan is continuously repeated until service is found. Since power consumption may not be a constraint when connected to an external power supply, the simplest way to ensure quick response to service availability is to repeat the power-up scan at Block 802 with no delay.

On the other hand, if the repeated power up scan fails and the wireless terminal is not connected to a battery charger, then at Block 810, the wireless terminal enters stage 1 of a three-stage process to find service. If service is found (i. e., SPs other than Forbidden SPs) at any time during the power-up method (Blocks 812, 816, 820), then at Block 806 the power-up method goes to the channel on which service is found and exits the power up scan.

It should be noted that during each stage 810, 814, and 818, frequency bands are scanned according to a sequence of bands called BAND_SEQ 832, 850. As noted above, the sequence of bands, BAND_SEQ is typically a fixed sequence that does not change. Once the array BAND_SEQ is determined, bands are preferably scanned one at a time at each increment, i, of the counter according to the order specified in BAND_SEQ. A time interval between scans of consecutive bands may change depending on the stage of scanning. When a counter index reaches a multiple, for example, of twelve, every band (e.g. a, b, A, B, C, D, E, F) can be scanned sequentially without time intervals between scans of consecutive bands. BAND_SEQ is generated, at least in part, based on the band priorities stated in the IRDB. Bands may be scanned according to the sequence BAND_SEQ to ensure, for example, that bands with higher priority are scanned more often in relation to lower priority bands. An example of how this sequence is generated will be described in detail below following a description of each stage of the power-up method.

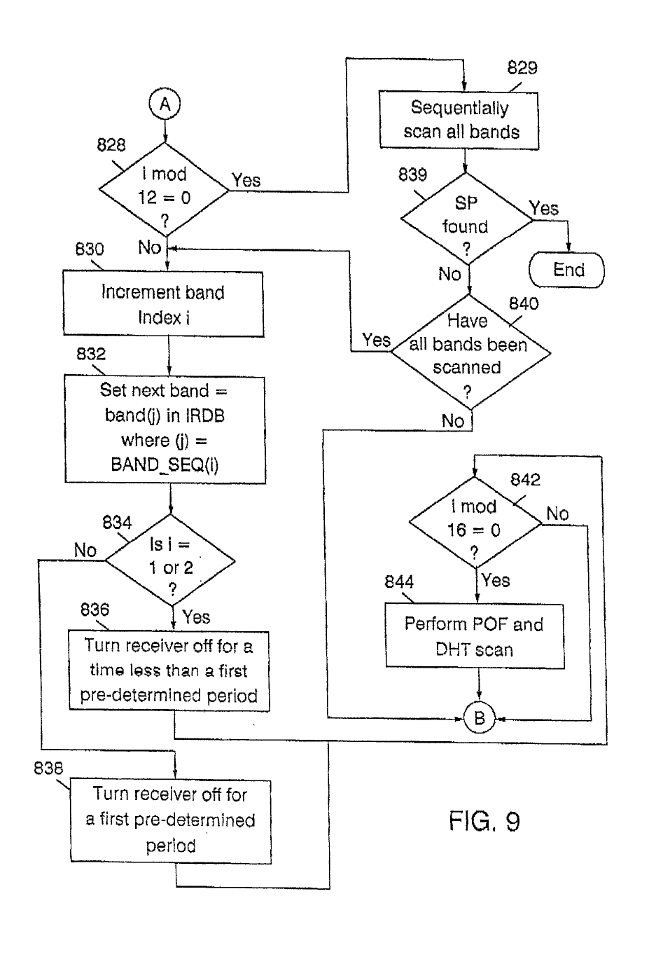

One example of the details of stage 1 are shown in FIG. 9, and will now be described. During stage 1 at Block 828, the power-up method first determines whether the counter is at a particular value (e.g., whether the counter is a multiple of 12).

If at Block 828 it is determined that the counter is at a particular value, then at Block 829 all of the bands are sequentially scanned, and at Block 839 it is determined whether or not a wireless communications channel has been found. If a channel is found at Block 839 then the power-up ends. However, if no channel is found at Block 839, then a determination is made at Block 840 whether or not all bands have been scanned. If all bands have been scanned, then the power-up technique proceeds to Block 830 where the band index counter is incremented. On the other hand, if, at Block 840, all bands have not been scanned, then the power-up technique proceeds to scan the next band according to BAND_SEQ(i) as per intervals of stage 1 until a service provider is found.

If at Block 828 it is determined that the counter is not, for example, a multiple of 12, then the power-up technique proceeds to Block 830 where the index, i, of the band index counter is incremented. Bands are preferably scanned one at a time according to the array BAND_SEQ(i), and the receiver is turned off for an interval of time between scans of consecutive bands in the BAND_SEQ. The time interval depends on which stage of scanning the power-up is currently in. At Block 832, the next band to be scanned is determined by indexing the sequence BAND_SEQ using the current value of the counter. At Block 834, the power-up technique determines if the index i is one or two. If so, at Block 836 the receiver is turned off for a time less than a first predetermined period after scanning each of the first two bands only. By contrast, if the current band being scanned is not the first or second band in the sequence, then at Block 838 the receiver is turned off for a first predetermined period. The predetermined time should be selected in a manner to ensure quick acquisition of service when service becomes available. In each case, after the receiver is turned back on the power-up method proceeds to Block 842.

POF and DHT scans may also be performed during the course of the power-up technique to ensure quick acquisition of service once service becomes available. At Block 842, whenever the index is a multiple of 16, for example, a POF scan may be performed before the next band is scanned. Moreover, a DHT scan may also be performed before the band scan whenever the highest priority band is scanned. After Block 844, the power-up technique proceeds to scan the next band according to BAND_SEQ(i) as per intervals of stage 1 operation. As indicated at Block 824 the power-up technique will remain in stage 1 for a first predetermined time after the power up scan has been started. At Block 824 a counter is started when stage 1 is entered and the counter is incremented by one thereafter each time a band is scanned.

Each time it is determined at Blocks 812, 816 and 820 that a service provider is not found, at Block 822, a determination is made whether the mean RSS has changed. Any significant changes can advantageously allow for detection of changes in the radio environment. If the mean has not changed significantly, then the power-up technique proceeds to check the elapsed time at either Block 824 or Block 826. Alternatively, the power-up technique may directly proceed to Block 846. Techniques for determining whether or not the mean RSS has changed significantly are discussed above. If a newly computed mean RSS differs from a previously stored mean RSS by more than 20 dB, for example, the power up is stopped, the power-up method restarts, and the power up scan is re-performed at Block 802.

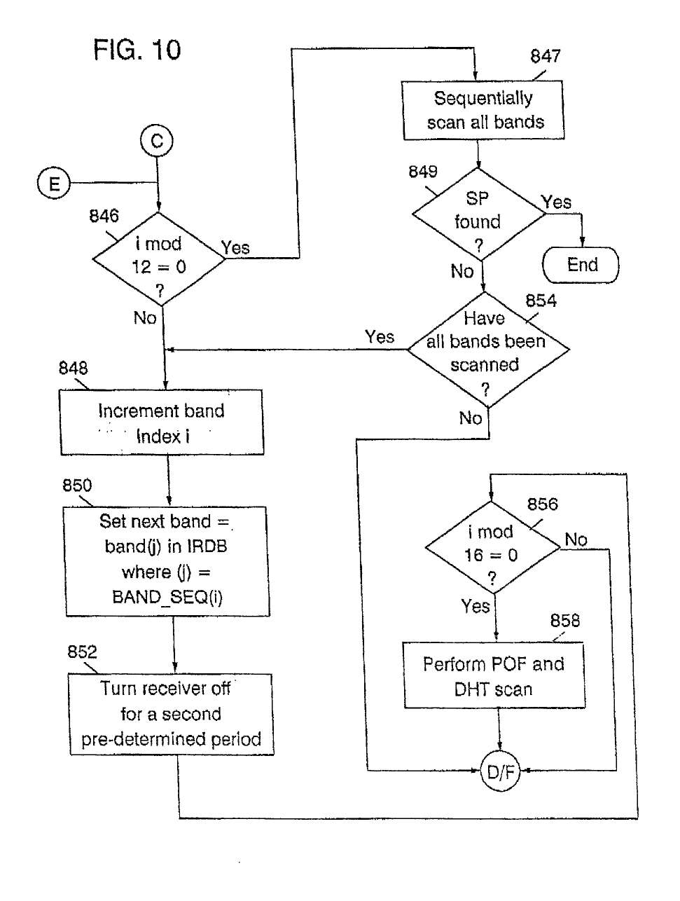

Once the first predetermined time has elapsed, if a service provider has not been found, at Block 814 the power-up method enters stage 2. As indicated at Block 826, the power-up technique remains in stage 2 for a second predetermined time. The details of stage 2 are shown in FIG. 10, and will be discussed in detail below. If a second predetermined time has elapsed after the commencement of power-up scan, and a service provider has still not been found, then stage 3 of the power-up scan will begin at Block 818. The power-up scan may remain in this stage until service is found. The details of stage 3 are also shown in FIG. 10, and will now be discussed in detail.

At Block 846, a determination is made whether the counter is presently a multiple of 12. If it is, every band is sequentially scanned for a service provider. If a wireless communications channel is found at Block 849, then the power-up ends. However, if no channel is found at Block 849, then at Block 854 it is determined whether all bands have been scanned. If at Block 854 it is determined that all bands have not been scanned, then the power-up technique proceeds to scan the next band specified by the stage of operation. If at Block 854 all bands have been scanned, then the operation proceeds to Block 848, where the index, i, is incremented. The counter is incremented through stages 2 and 3 without being reset. At Block 846, if it is determined that the counter is not presently at a multiple of 12, for example, then the band index counter is incremented at Block 848. At Block 850 the next band to be scanned is determined by indexing the sequence BAND_SEQ using the current value of the counter. At Block 852, the receiver is turned off for a second predetermined time period between band scans. This second predetermined time period is preferably greater than the first predetermined time period. As mentioned above, turning off the receiver helps to conserve power. Prior to scanning the next band, the receiver is turned back on and the power-up technique proceeds to Block 856. Again, to enable quick acquisition of service when service becomes available POF and DHT scans may be periodically performed during the course of the power-up technique. For example, at Block 858 a DHT scan may be performed before the band scan whenever the highest priority band is scanned. As indicated at Block 856, whenever the counter is a multiple of 16, a POF scan is also performed in addition before the band being scanned. Periodically performing a POF scan and/or a DHT scan ensures that all the elements of the power up scan are performed within the power-up method. Periodically performing a POF scan and/or a DHT scan also enable quick acquisition of service when service becomes available.

Scanning complexity may also be reduced during stage 2 and stage 3 in ways other than turning off the receiver. For example, during stage 2, the number of channels processed after RSS measurement may be reduced to the top two channels in the list instead of the whole list. Moreover, during stage 3, scanning complexity may be further reduced by measuring RSS only on two sub-bands for the 1900 MHz bands and on 4 sub-bands for the 800 MHz bands. Scanning complexity may be further reduced during stages 2 and 3, by accepting unacceptable SPs thereby allowing the user to have service with some SP before the most suitable SP is found.

As mentioned above, during each of stages 1, 2 and 3, frequency bands are scanned according to a sequence of bands, called BAND_SEQ, which is generated, at least in part, based on the band priorities stated in the IRDB. The band sequence (or scanning order) BAND_SEQ may be generated according to the following operations:

(1) Define NUM_BANDS as the number of bands in the IRDB.

(2) Define NUM_GROUPS=[log₂(NUM_BANDS+1)], where [x] rounds up the argument x.

(3) Define NUM_IN_GROUPS(i)=2⁽ⁱ⁻¹⁾ for i ε1 . . . (NUM_GROUPS−1) and NUM_IN_GROUPS(NUM_GROUPS)=NUM_BANDS−Σᵢ₌₁^{NUM}^{_{—}}^{Groups-1} NUM_IN_GROUPS(i).

(4) Define NUM_CYCLE(i)=2^{NUM}^{_{—}}^{GROUPS-1}, for i=1. . . NUM_GROUPS.

(5) Define NUM_IN_CYCLEΣᵢ₌₁^{NUM}^{_{—}}^{Groups} NUM_CYCLE(i) NUM_IN_GROUPS(i).

(6) Define GROUP_NUM(i)=Band (Σⱼ₌₁^{i -1} NUM_IN_GROUPS +1) in IRDB to band (Σⱼ₌₁ⁱ NUM_IN_GROUPS) in IRDB for i>1 and define GROUP_NUM(1)=band 1 in IRDB.

(7) Create a cycle of length NUM_IN_CYCLE bands from sub-cycles of length NUM_GROUPS where band i in the sub-cycle is chosen from the bands in GROUP_NUM(i)

(8) The band chosen for band i in a sub-cycle should be the band from within GROUP_NUM(i) after the one chosen for the previous sub-cycle with the condition that if the band in the previous sub-cycle was the last band in the group, then the first band in GROUP_NUM(i) is chosen.

(9) If the next band in GROUP_NUM(i) has already appeared NUM_CYCLE(i) times in the current cycle, then the next channel in GROUP_NUM(i) that has not already appeared NUM_CYCLE(i) times is chosen for the ith element of the sub-cycle.

(10) If all the bands in GROUP_NUM(i) have already appeared NUM_CYCLE(i) times in the current cycle, then the next channel in GROUP_NUM(j) with the lowest index j that has bands that have appeared less than NUM_GYCLE(j) times in the current cycle is chosen as the i^{th} element of the sub-cycle.

(11) If the last sub-cycle causes the length of the cycle to be greater than NUM_IN_CYCLE, the end of the sub-cycle is truncated so that the total number of bands will equal NUM_IN_CYCLE.

One result of these operations is that bands are prioritized by grouping them into classes with decreasing priority. The sequence is characterized in that bands of lower priorities are not likely to have large differences in the probabilities of finding service in them. As a result, these operations group together a larger number of bands at the lower priorities (i.e., lower priority groups are larger than higher priority groups). Moreover, the band order generated by these operations is advantageous since the sequence BAND_SEQ ensures that bands with higher priority are scanned more often in relation to lower priority bands. As a result, bands that are more likely to contain service (as determined by the IRDB band order) can be scanned more often. Another advantage of these operations is that the number of priority classes of bands (NUM_GROUPS) is the logarithm of the number of total bands; therefore, these operations are not complex even when the number of bands is very high. Since the number of total bands in a particular market may vary from market to market, the scalability of these operations is advantageous since these operations will work across a wide range of total bands. Yet another advantage of these operations is that they distribute band scans for a particular band as evenly as possible, which in turn minimizes the probability that the same band is scanned consecutively.

The use of the above operations produced the results below for the case where ten bands are to be scanned. The final array produced is a sequence containing numbers chosen between 1 and 10 where the number i indicates the band with priority i.

NUM_BANDS=10

NUM_GROUPS=4

NUM_IN_GROUPS=[1 2 4 3]

NUM_CYCLE=[8 4 2 1]

NUM_IN_CYCLE=8×1+4×2+2×4+3×1=27

GROUP_NUM [1, (2, 3), (4, 5, 6, 7) (8, 9, 10)]

BAND_SEQ=1,2,4,8, 1,3,5,9, 1,2,6,10, 1,3,7,1, 1,2,4,1, 1,3,5, 2, 3,6,7

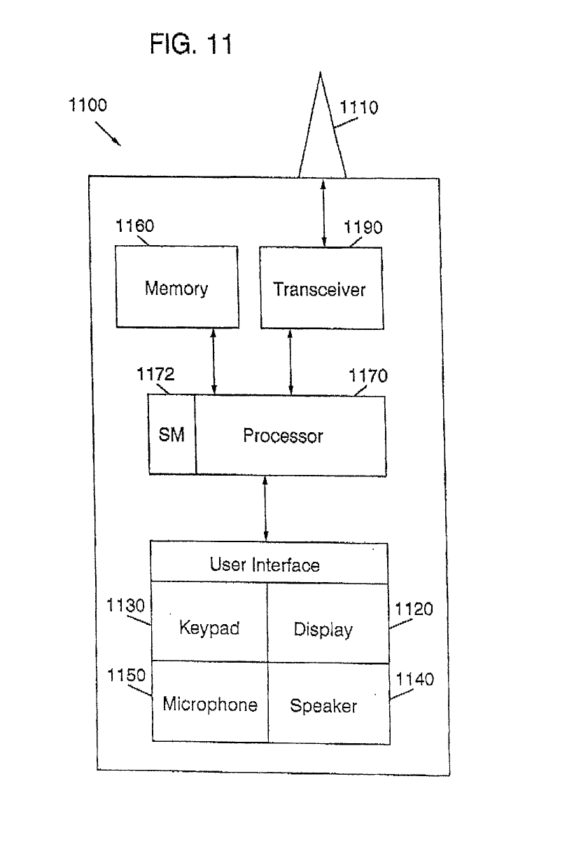

FIG. 11 illustrates exemplary wireless terminals 1100 according to embodiments of the present invention. The wireless terminals 1100 include a transceiver (i.e., receiver and transmitter) 1190 that is operative to transmit and receive RF communication signals via an antenna 1110 under control of a processor 1170. The processor 1170 includes scanning means 1172 as well as other functional modules not illustrated in FIG. 11 but which will be understood to those of skill in the art related to wireless communications including both data and voice communication support. The processor 1170 processes messages to produce physical layer bursts that are transmitted over physical wireless channels by the transceiver 1190 via the antenna 1110. The scanning means 1172 includes a power-up circuit, a detection circuit, a RSS measurement circuit, and at least one scanning circuit.

The processor 1170, such as a microprocessor, microcontroller or similar data processing device, may execute program instructions stored in a memory 1160 of the wireless terminal 1100, such as a Dynamic Random Access Memory (DRAM), Electrically Erasable Programmable Read-Only Memory (EEPROM) or other storage device. The processor 1170 is further operatively associated with user interface components of the wireless terminal 1100 such as a display 1120, a keypad 1130, a speaker 1140, and a microphone 1150, operations of which are known to those of skill in the art and will not be further discussed herein.

It will be appreciated that the transceiver 1190 and other components of the wireless terminal 1100 may be implemented using a variety of hardware and software. For example, operations of the transceiver 1190 may be implemented using special-purpose hardware, such as an Application Specific Integrated Circuit (ASIC) and programmable logic devices such as gate arrays, and/or software or firmware running on a computing device such as a microprocessor, microcontroller or Digital Signal Processor (DSP). It will also be appreciated that, although functions of the transceiver 1190 and/or the scanning means 1172 may be integrated in a single device, such as a single ASIC microprocessor, they may also be distributed among several devices. Aspects of the transceiver 1190, the scanning means 1172 and the processor 1170 may also be combined in one or more devices, such as an ASIC, DSP, microprocessor or microcontroller.

The wireless terminal 1100 shown in FIG. 11 may receive a plurality of control channels from various communication service providers such as the Analog Control Channel (ACC) and/or the Digital Control Channel (DCCH). It is to be further understood that the wireless communication systems generating the control channels may include a variety of different configurations of components such as base stations, sometimes referred to as “base transceiver stations,” wireless terminal Switching Centers (MSCs), telecommunications switches, and other communications components.

The scanning means 1172 and /or the memory 1160 are responsible for executing the power-up methods described above. For example, each power-up process, scanning function, detection function, confirmation function, measurement function and switching function is implemented, at least in part, by the scanning means 1172 and/or memory 1160 working in conjunction with each other.

The transceiver 1190 as illustrated in the embodiments of FIG. 11 may include a receiver configured to receive wireless communication signals including the control channels. The detection circuit is configured to detect the control channel signals from received wireless communication signals. The scanning circuit is configured to repeatedly scan a decreasing number of communication channels to detect at least one pre-specified wireless communications channel. The scanning circuit is preferably configured to scan higher priority communications channels more frequently than low priority communications channels in each scan. The scanning circuit also preferably performs each scan operation after turning the transceiver off for a predetermined delay time in order to reduce current consumption by the wireless terminal when scanning for a service provider in situations where none are available. The configuration of the scanning circuit is explained above with reference to the flowchart illustrations of in describing exemplary operations for various embodiments of the present invention.

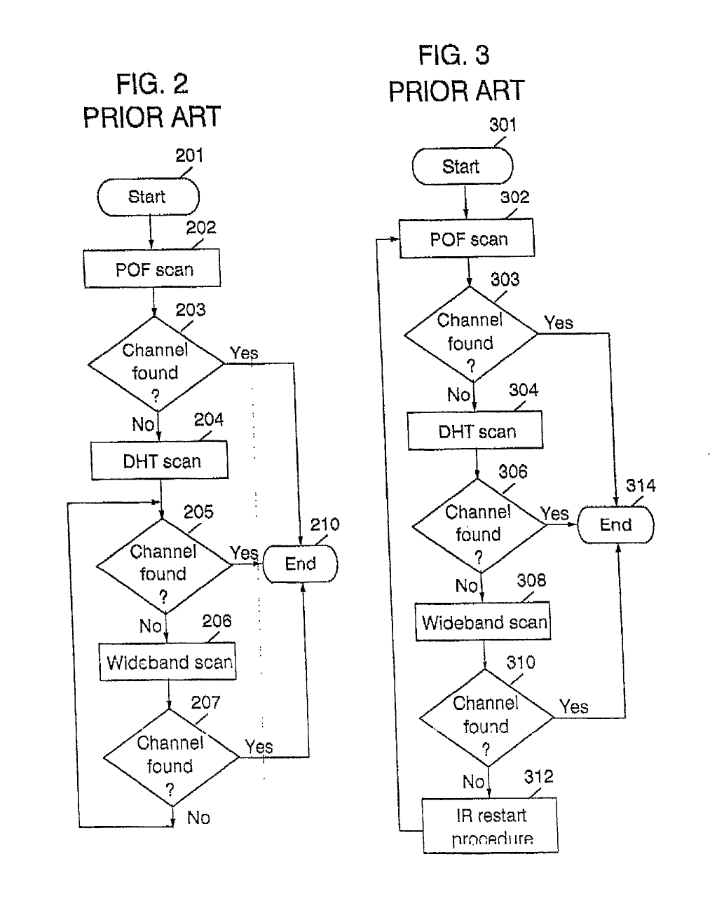

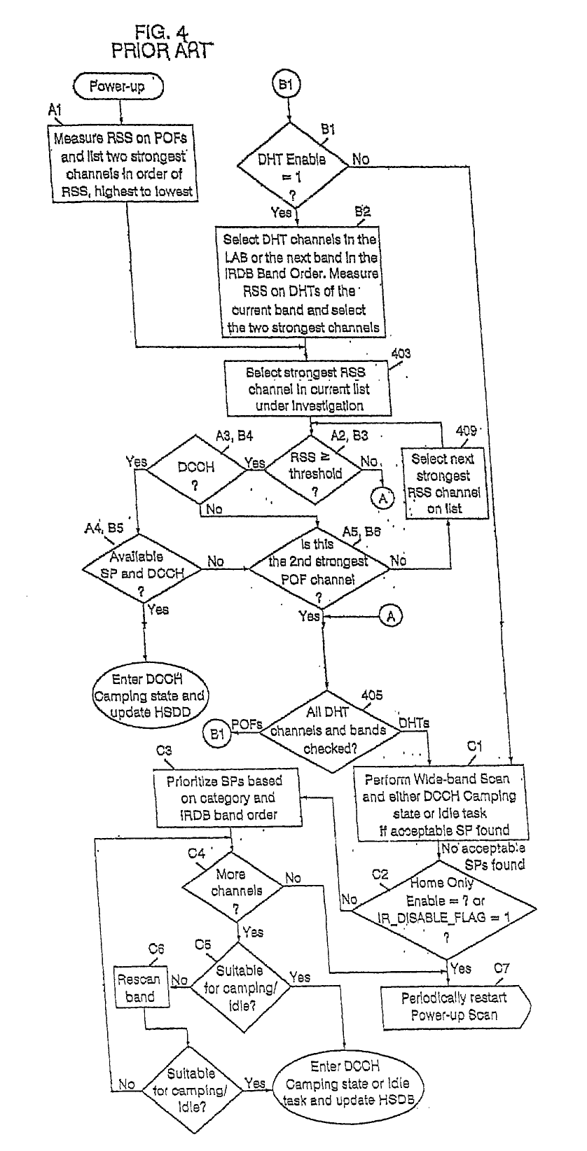

FIGS. 2-10 are flowchart illustrations illustrating exemplary operations for performing power-up methods according to embodiments of the present invention. It will be understood that blocks of the flowchart illustrations of FIGS. 2-10 and of the block diagram illustrations of FIG. 11 and combinations of blocks in the flowchart illustrations and block diagram may be implemented using electronic circuits included in wireless terminals configured to operate in wireless communications systems. It will also be appreciated that blocks of the flowchart illustrations of FIGS. 2-10 and of the block diagram illustration of FIG. 11, and combinations of blocks in the flowchart illustrations and block diagram, may be implemented in special purpose hardware such as discrete analog and/or digital circuitry, such as combinations of integrated circuits or one or more Application Specific Integrated Circuits (ASICs), as well as by computer program instructions which may be loaded onto a computer or other programmable data processing apparatus to produce a machine such that the instructions which execute on the computer or other programmable data processing apparatus create means for implementing the functions specified in the flowchart block or blocks. The computer program instructions may also be loaded onto a computer or other programmable data processing apparatus to cause a series of operations to be performed on the computer or other programmable apparatus to produce a computer implemented process such that the instructions which execute on the computer or other programmable apparatus provide operations for implementing the functions specified in the flowchart block or blocks.

Accordingly, blocks of the flowchart illustrations of FIGS. 2-10 support electronic circuits and other means for performing the specified functions, as well as combinations of operations for performing the specified functions. It will be understood that the circuits and other means supported by each block of the flowchart illustrations of FIGS. 2-10, and combinations of blocks therein, can be implemented by special purpose hardware, software or firmware operating on special or general purpose data processors, or combinations thereof.

In the drawings and specification, there have been disclosed typical preferred embodiments of the invention and, although specific terms are employed, they are used in a generic and descriptive sense only and not for purposes of limitation, the scope of the invention being set forth in the following claims.

That which is claimed:

1. A power-up method for a wireless terminal, comprising:
performing a first power-up process to attempt to detect a wireless communications channel while consuming a first amount of power; and
performing a second power-up process to attempt to detect a wireless communications channel while consuming a second amount of power that is less than the first amount, upon failure of the first power-up process to detect a wireless communications channel for the wireless terminal.

2. A method according to claim 1:
wherein the step of performing a first power-up process comprises scanning a first plurality of wireless communications channels to attempt to detect a wireless communications channel; and
wherein the step of performing a second power-up process comprises scanning a second plurality of wireless communications channels, to attempt to detect a wireless communications channel.

3. A method according to claim 2, wherein the step of scanning a second plurality of wireless communications channels, comprises:
repeatedly scanning selected ones of the second plurality of communications channels more frequently than selected others of the second plurality of communications channels in each scan.

4. A method according to claim 3, wherein the selected ones of the second plurality of wireless communications channels have a first priority designation and the selected others of the second plurality of wireless communications channels have a second priority designation that is lower than the first priority designation.

5. A method according to claim 3, wherein the repeatedly scanning step further comprises:
scanning a first decreasing number of the second plurality of communications channels;
detecting changes in the first decreasing number of the second plurality of communications channels;
scanning a second decreasing number of the second plurality of communications channels if changes are not detected; and
reperforming the first power-up process if changes are detected.

6. A method according to claim 5, wherein the step of detecting changes comprises:
measuring a mean received signal strength (RSS) for the second plurality of wireless communications channels; and
detecting changes in the mean RSS for the second plurality of wireless communications channels.

7. A method according to claim 6, wherein the RSS is a first RSS, and wherein the step of detecting changes in the mean RSS, comprises:
rescanning the second plurality of wireless communications channels;
measuring a second mean received signal strength (RS S) for the second plurality of wireless communications channels; and
determining whether the second mean RSS exceeds the first mean RSS by more than a predetermined amount.

8. A method according to claim 7, further comprising:
stopping the second power-up process if the second mean received signal strength (RSS) exceeds the mean received signal strength (RSS) by more than a predetermined amount; and
re-performing the first power-up process.

9. A method according to claim 1, wherein the step of performing a first power-up process is followed by:
confirming that the step of performing the second power-up process should be executed.

10. A method according to claim 9, wherein the step of confirming, comprises:
determining that the wireless terminal is not connected to an external power supply.

11. A method according to claim 1, wherein the step of performing the first power-up process comprises:
performing a Private Operating Frequency (POF) scan;
performing a Digital control channel History Table (DHT) scan; and
performing a wideband scan.

12. A method according to claim 1, wherein the step of performing the second power-up process is preceded by:
switching a receiver of the wireless terminal off thereby reducing power consumption of the wireless terminal.

13. A method according to claim 3, wherein the step of repeatedly scanning is preceded by the step of performing a Digital control channel History Table (DHT) scan each time selected ones of communications channels are scanned.

14. A method according to claim 3, further comprising:
periodically performing a Private Operating Frequency (POF) scan before the step of repeatedly scanning.

15. A method according to claim 8, further comprising reducing the number of channels on which RSS is measured each time the repeatedly scanning step is performed.

16. A method according to claim 1, wherein the step of performing the second power-up process comprises:
scanning a first plurality of frequency bands each of which includes at least one communications channel.

17. A method according to claim 16, wherein the step of scanning a first plurality of frequency bands comprises:
scanning a highest priority frequency band for a wireless communications channel; and
if no wireless communications channel is detected by scanning the highest priority frequency band, scanning at least one lower priority frequency band according to a sequence wherein higher priority bands are scanned more often than the lower priority bands.

18. A power-up scan method for a wireless terminal comprising:
repeatedly performing a power-up process to attempt to detect a wireless communications channel while consuming decreasing amounts of power in each succeeding power-up process, in response to failure of a preceding power-up process to detect a wireless communications channel for the wireless terminal.

19. A method according to claim 18, wherein each succeeding power-up process is performed after a delay time that increases with each succeeding power-up process.

20. A method according to claim 19, wherein each succeeding power-up process comprises repeatedly s canning a plurality of wireless communications channels to attempt to detect at least one pre-specified wireless communications channel.

21. A method according to claim 20, wherein the step of repeatedly scanning a plurality of wireless communications channels further comprises scanning selected ones of the wireless communications channels more frequently than selected others of the wireless communications channels in each successive scan.

22. A power-up scan method for a wireless terminal that accesses a wireless communications system using a plurality of first communications channels having a first priority designation and a plurality of second communications channels having a second priority designation that is lower than the first priority designation, comprising:
repeatedly scanning the first and second communications channels to attempt to detect a wireless communications channel, while scanning more of the first communications channels relative to the second communications channels in each successive scan, in response to failure of a preceding scan to detect a wireless communications channel for the wireless terminal.

23. A method according to claim 22, wherein each successive scan consumes less power than the preceding scan.

24. A method according to claim 23, wherein each successive scan is performed after a delay time that increases with each successive scan.

25. A method according to claim 22, wherein the plurality of first communications channels are scanned more frequently than the plurality of second communications channels in each scan.

26. A method according to claim 22, wherein the first and second communications channels are repeatedly scanned according to a variable sequence wherein the occurrence of the first communications channels is greater than the occurrence of second communications channels scanned during each scan.

27. A method according to claim 22, wherein the step of repeatedly scanning the first and second communications channels comprises:
repeatedly scanning a first and a second plurality of frequency bands each of which includes at least one communications channel.

28. A method according to claim 27, wherein the step of repeatedly scanning the first plurality of frequency bands comprises:
scanning at least one highest priority frequency band for a wireless communications channel; and
if no wireless communications channel is detected by scanning the highest priority frequency band, scanning at least one lower priority frequency band according to a sequence wherein higher priority bands are scanned more often than the lower priority bands.

29. A power-up scan method for a wireless terminal that accesses a wireless communications system using a plurality of communications channels, each of the channels having a predetermined priority, the plurality of communications channels including at least one higher priority communications channel, comprising the steps of:
repeatedly scanning the plurality of communications channels according to a variable sequence wherein the occurrence of higher priority communications channels is greater than the occurrence of lower priority communications channels with each successive scan.

30. A method according to claim 29, wherein during each successive scan a decreasing number of the plurality of communications channels are scanned.

31. A method according to claim 29, wherein each successive scan consumes less power than the preceding scan.

32. A restart method for a wireless terminal that accesses a wireless communications system using a plurality of groups of frequency bands, each group having a relative priority designation, comprising:
scanning the plurality of groups of frequency bands such that groups of frequency bands having a high relative priority designation are scanned more frequently than groups of frequency bands having a lower relative priority designation.

33. A restart method according to claim 32, wherein the number of bands in each group decreases as the relative priority designation of that group increases

34. A wireless terminal, comprising:
a wireless receiver that receives a plurality of wireless communications channels;
means for performing a first power-up process to attempt to detect a wireless communications channel via the wireless receiver, the means for performing the first power-up process consuming a first amount of power; and
means for performing a second power-up process to attempt to detect a wireless communications channel via the wireless receiver upon failure of the first power-up process to detect a wireless communications channel for the wireless terminal;
wherein the means for performing the second power-up process consumes a second amount of power that is less than the first amount of power.

35. A wireless terminal, according to claim 34:
wherein the means for performing a first power-up process comprises means for scanning a first plurality of wireless communications channels to attempt to detect a wireless communications channel; and
wherein the means for performing a second power-up process comprises means for scanning a second plurality of wireless communications channels, to attempt to detect a wireless communications channel.

36. A wireless terminal, according to claim 35:
wherein the means for scanning a second plurality of wireless communications channels further comprises means for repeatedly scanning selected ones of communications channels more frequently than selected others of communications channels in each scan.

37. A wireless terminal according to claim 36:
wherein the selected ones of communications channels have a first priority designation and the selected others of communications channels have a second priority designation that is lower than the first priority designation.

38. A wireless terminal according to claim 36, wherein the means for repeatedly scanning further comprises:
means for scanning a first decreasing number of the second plurality of communications channels;
means for detecting changes in the first decreasing number of the second plurality;
means for scanning a second decreasing number if changes are not detected; and
means for performing the first power-up process if changes are detected.

39. A wireless terminal, according to claim 38, wherein the means for detecting changes comprises:
means for measuring a mean Received Signal Strength (RSS) of the wireless communications channels; and
means for detecting changes in the mean RSS for the wireless communications channels.

40. A wireless terminal, according to claim 39, wherein the RSS is a first RSS, and wherein the means for detecting changes in the mean RSS comprises:
means for rescanning the wireless communications channels;
means for measuring a second mean received signal strength (RSS) for the wireless communications channels; and
means for determining whether the second mean RSS exceeds the mean RSS by more than a predetermined amount.

41. A wireless terminal, according to claim 40, further comprising:
means for stopping the second power-up process if the second mean Received Signal Strength (RSS) exceeds the mean Received Signal Strength (RSS) by more than a predetermined amount; and
means for re-performing the first power-up process.

42. A wireless terminal, according to claim 34:
wherein the means for performing a first power-up process further comprises means for confirming that the step of performing the second power-up process should be executed.

43. A wireless terminal, according to claim 42:
wherein the means for confirming further confirms that the wireless terminal is not connected to an external power supply.

44. A wireless terminal, according to claim 34, wherein the means for performing the first power-up process comprises:
means for performing a Private Operating Frequency (POF) scan;
means for performing a Digital control channel History Table (DHT) scan; and
means for performing a wideband scan.

45. A wireless terminal, according to claim 34:
wherein the means for performing the second power-up process further comprises means for switching a receiver of the wireless terminal off thereby reducing current consumption of the wireless terminal.

46. A wireless terminal, according to claim 35, further comprising:
means for performing a Digital control channel History Table (DHT) scan, each time selected ones of communications channels are scanned, before repeatedly scanning.

47. A wireless terminal, according to claim 35, further comprising:
means for periodically performing a private operating frequency (POF) scan before repeatedly scanning.

48. A wireless terminal, according to claim 41, further comprising:
means for reducing the number of channels on which RSS is measured each time the repeatedly scanning step is repeated.

49. A wireless terminal, according to claim 34:
wherein the means for performing the first power-up process further comprises means for scanning a first plurality of frequency bands each of which includes at least one communications channel.

50. A wireless terminal, according to claim 49, wherein the means for scanning a first plurality of frequency bands comprises:
means for scanning a highest priority frequency band for a wireless communications channel; and
means for scanning at least one lower priority frequency band according to a sequence wherein higher priority bands are scanned more often than the lower priority bands, if no wireless communications channel is detected by scanning the highest priority frequency band.

51. A wireless terminal, comprising:
a wireless receiver that receives a plurality of wireless communications channels;
a wireless terminal controller that performs a first power-up process to detect a wireless communications channel via the wireless receiver, and that performs a second power-up process to detect a wireless communications channel via the wireless receiver upon failure of the first power-up process to detect a wireless communications channel for the wireless terminal;
wherein the wireless terminal consumes a first amount of power during the first power-up process and consumes a second amount of power during the second power-up process that is less than the first amount of power.

52. A wireless terminal, according to claim 51:
wherein the wireless terminal controller controls the wireless receiver to scan a first plurality of wireless communications channels to detect a wireless communications channel, and to scan a second plurality of wireless communications channels, to attempt to detect a wireless communications channel.

53. A wireless terminal, according to claim 52:
wherein the wireless terminal controller controls the wireless receiver to repeatedly scan selected ones of communications channels more frequently than selected others of communications channels in each scan.

54. The wireless terminal according to claim 53:
wherein the selected ones of communications channels have a first priority designation and the selected others of communications channels have a second priority designation that is lower than the first priority designation.

55. A wireless terminal according to claim 53, wherein the wireless terminal controller further controls the wireless receiver to repeatedly scan by:
controlling the wireless receiver to scan a first decreasing number of the second plurality of communications channels;
detecting changes in the first decreasing number of the second plurality;
controlling the wireless receiver to scan a second decreasing number of the second plurality of communications channels if changes are not detected by the detection circuit; and
performing the first power-up process if changes are detected.

56. A wireless terminal, according to claim 55, wherein wireless terminal controller detects changes by:
measuring a mean Received Signal Strength (RSS) of the wireless communications channels; and
detecting changes in the mean RSS of the wireless communications channels.

57. A wireless terminal, according to claim 51:
wherein the wireless terminal controller confirms that the second power-up process should be performed.

58. A wireless terminal, according to claim 57:
wherein the wireless terminal controller further confirms that the second power-up process should be performed by confirming that the wireless terminal is not connected to an external power supply.

59. A wireless terminal, according to claim 51, wherein:
wireless terminal controller further controls the wireless terminal receiver to perform a Private Operating Frequency (POF) scan, a Digital control channel History Table (DHT) scan, and a wideband scan.

60. A wireless terminal, according to claim 51:
wherein the wireless terminal controller fur ther switches a receiver of the wireless terminal off thereby reducing current consumption of the wireless terminal.

61. A wireless terminal, according to claim 56, wherein the wireless terminal controller further controls the wireless terminal receiver by reducing the number of channels on which RSS is measured each time the receiver repeatedly scans.

62. A wireless terminal, according to claim 51:
wherein a wireless terminal controller controls the wireless terminal receiver by scanning a first plurality of frequency bands each of which includes at least one communications channel.

63. A wireless terminal, according to claim 62, wherein the controller controls the wireless terminal receiver to scan a highest priority frequency band for a wireless communications channel, and then scan at least one lower priority frequency band according to a sequence wherein higher priority bands are scanned more often than the lower priority bands, if no wireless communications channel is detected by scanning the highest priority frequency band.

64. A power-up scan method for a wireless terminal that accesses a wireless communications system using a plurality of first communications channels having a first priority designation and a plurality of second communications channels having a second priority designation that is lower than the first priority designation, comprising:
repeatedly scanning the first and second communications channels to attempt to detect a wireless communications channel, while scanning more of the first communications channels relative to the second communications channels as scanning progresses, in response to failure of a preceding scan to detect a wireless communications channel for the wireless terminal.

65. A method according to claim 64, wherein the ratio of first communications channels to second communications channels increases as scanning progresses.

66. A method according to claim 64, wherein the first and second communications channels are repeatedly scanned according to a variable sequence wherein the occurrence of the first communications channels is greater than the occurrence of second communications channels as scanning progresses.
